(19) United States
(12) Patent Application Publication
(10) Pub. No.: US 2017/0223116 A1
(43) Pub. Date: Aug. 3, 2017

(54) ADAPTATION OF ENVIRONMENT BASED ON DATA RECEIVED FROM WEARABLE DEVICES

(71) Applicant: International Business Machines Corporation, Armonk, NY (US)

(72) Inventors: Alberto G. Herrera Chávez, Morelia (MX); Paul Llamas Virgen, Ciudad Guzman (MX); Carlos A. Martínez Vázquez, Tlaquepaque (MX); Jose R. Mosqueda Mejia, Puruandiro (MX)

(21) Appl. No.: 15/049,264

(22) Filed: Feb. 22, 2016

Related U.S. Application Data
(63) Continuation of application No. 15/012,048, filed on Feb. 1, 2016.

(51) Int. Cl. H04L 29/08; H04B 1/3827

(52) U.S. Cl. CPC H04L 67/16; H04L 67/306; H04B 1/385

(57) ABSTRACT

A computer detects one or more portable computing devices in an environment. The computer receives information detailing one or more user preferences from the one or more portable computing devices. The computer determines whether to update one or more conditions of the environment based on comparing the received information to the one or more conditions of the environment. Based on determining to update the one or more conditions of the environment, the computer updates the one or more conditions of the environment.

### TECHNICAL FIELD

The present invention relates to adaptation of an environment, and more particularly to the adaptation of an environment based on data received from wearable devices.

### BACKGROUND

In the digital age, the utilization of wearable devices has become increasingly popular. Wearable devices provide a way for a person to stay connected to the world when they are on the go, in real time. For example, a wearable device, such as smart glasses may allow a person to get information on things that are viewed through the glasses on demand or even automatically. Wearable devices represent possibly the manner in which information will be disseminated from person to person in the near future.

### SUMMARY

The present invention provides a method, system, and computer program product for adapting an environment, in accordance to an embodiment of the invention. A computer detects one or more portable computing devices in an environment. The computer receives information detailing one or more user preferences from the one or more portable computing devices. The computer determines whether to update one or more conditions of the environment based on comparing the received information to the one or more conditions of the environment. Based on determining to update the one or more conditions of the environment, the computer updates the one or more conditions of the environment.

### BRIEF DESCRIPTION OF THE DRAWINGS

FIG. 1 illustrates an adaptation system, in accordance with an embodiment of the invention.

FIG. 2 is a flowchart illustrating the operations of the environment program of FIG. 1, in accordance with an embodiment of the invention.

FIG. 3 is a block diagram depicting the hardware components of the adaptation system of FIG. 1, in accordance with an embodiment of the invention.

### DETAILED DESCRIPTION

Embodiments of the present invention will now be described in detail with reference to the accompanying Figures.

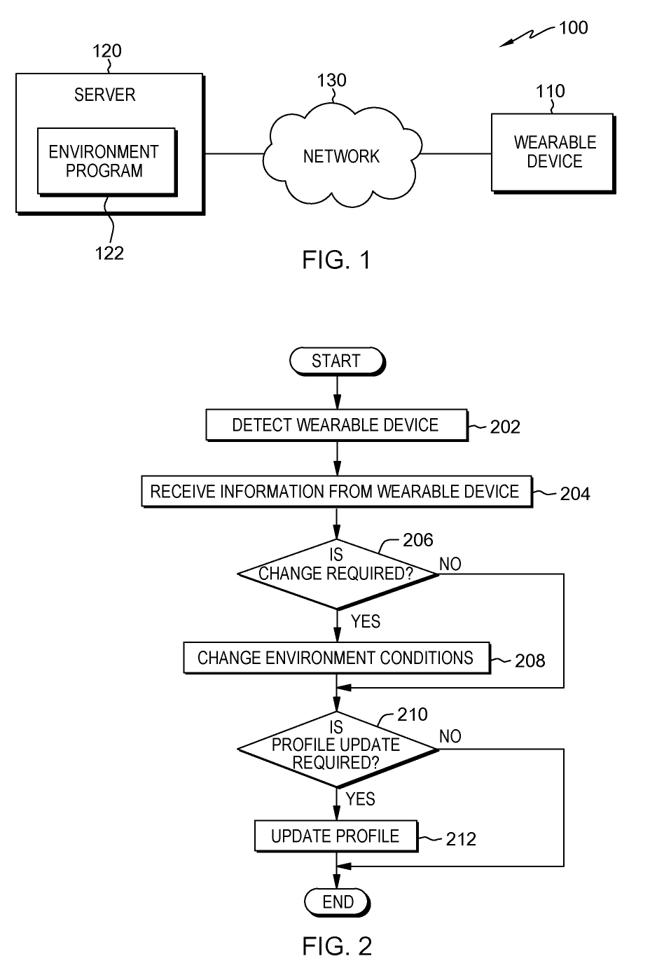

FIG. 1 illustrates adaptation system 100, in accordance with an embodiment of the invention. In an exemplary embodiment, adaptation system 100 includes wearable device 110 and server 120 interconnected via network 130.

In the exemplary embodiment, network 130 is the Internet, representing a worldwide collection of networks and gateways to support communications between devices connected to the Internet. Network 130 may include, for example, wired, wireless or fiber optic connections. In other embodiments, network 130 may be implemented as an intranet, a local area network (LAN), or a wide area network (WAN). In general, network 130 can be any combination of connections and protocols that will support communications between wearable device 110 and server 120.

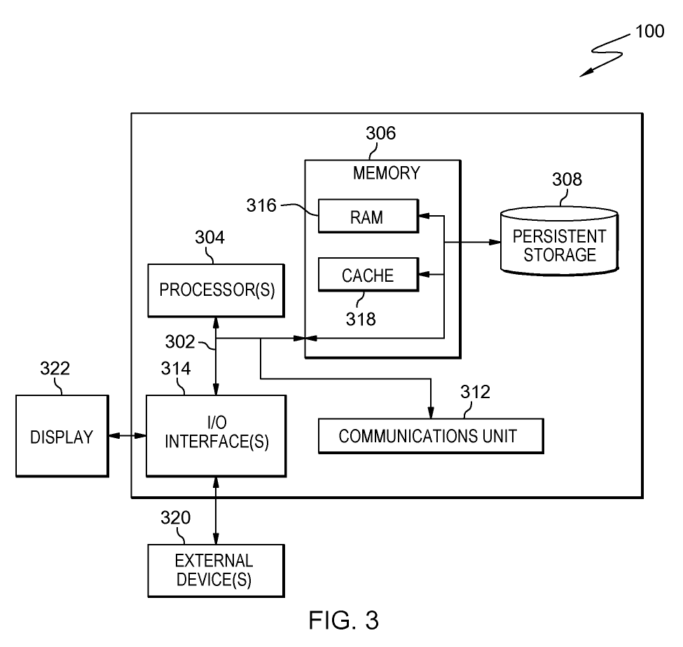

In the example embodiment, wearable device 110 is a portable computing device capable of receiving and sending data to and from other computing devices, such as server 120, via a network, such as network 130. For example, a wearable device may include a tablet computer, a smart watch, smart glasses, a handheld device, a smart-phone, a thin client, or an alternative portable device. Wearable device 110 is described in more detail with reference to FIG. 3.

Server 120 includes environment program 122. Server 120 may be a desktop computer, a notebook, a laptop computer, a tablet computer, a handheld device, a smart-phone, a thin client, or any other electronic device or computing system capable of receiving and sending data to and from other computing devices, such as wearable device 110, via network 130. Although not shown, optionally, server 120 can comprise a cluster of servers executing the same software to collectively process requests as distributed by a front end server and a load balancer. Server 120 is described in more detail with reference to FIG. 3.

Environment program 122 is capable of detecting whether a wearable device, such as wearable device 110 is within an environment, such as a domicile, a park, a commercial building, an area, and the like. In the example embodiment, environment program 122 is capable of communicating with detected wearable devices, such as wearable device 110, via network 130. Environment program 122 is also capable of updating or changing the conditions of an environment based on information received from wearable devices. In addition, environment program 122 is capable of determining whether a profile associated with an environment should be updated. Environment program 122 is described in further detail below with reference to FIG. 2.

FIG. 2 is a flowchart illustrating the operations of environment program 122 in determining whether to change environment conditions based on received information, in accordance with an embodiment of the invention. In the example embodiment, environment program 122 detects wearable device 110 (step 202) by way of detecting when wearable device 110 connects to network 130. In one embodiment, environment program 122 may utilize sensors to detect when the user of wearable device 110 enters an environment associated with environment program 122. In other embodiments, environment program 122 may be integrated with an application capable of generating a hotspot of wireless signal which may allow wearable device 110 to directly connect with the associated application.

Environment program 122 receives information from wearable device 110 (step 204). In the example embodiment, environment program 122 receives information related to the user of wearable device 110 such as heart rate information, body temperature, emotional state information (if wearable device 110 is capable of determining an estimated emotional state of the user), information related to the motion of the user, and any information related to the profile of the user (such as preferred temperature settings, social media information, preferred music, favorite television shows, and preferred mode of entertainment information).

Environment program 122 determines whether the conditions of the environment associated with environment program 122 should be changed (decision 206). In the example embodiment, environment program 122 determines whether the conditions of the environment should be changed based on analyzing the information received from wearable device 110 and comparing the analyzed information to the current environment conditions. For example, environment program 122 may receive information from wearable device 110 regarding the user's favorite television channel or television programming (i.e., sports). Environment program 122 may then compare the received information to the current environment (the channel the television is on) by way of network 130.

If environment program 122 determines that the conditions of the environment associated with environment program 122 should be changed (decision 206, “YES” branch), environment program 122 changes the environment (step 208). Referring to the example above, if environment program 122 determines that the television channel is not on a sports network, based on analysis of the received information from wearable device 110, environment program 122 will turn the television in the environment to a sports channel.

If environment program 122 determines that the conditions of the environment associated with environment program 122 should not be changed (decision 206, “NO” branch), environment program 122 determines if one or more profiles related to the environment need to be updated (decision 210). In the example embodiment, environment program 122 may maintain environment profiles (which are stored on server 120 or another computing device). For example, environment program 122 may maintain an environment profile for the room temperature based on certain factors such as the time of day, time of year (season), and the day of the week. Additionally, the environment profile may be based on the actual environment type or location. For example, the environment profile for the room temperature for a bank may be a based on the potential impact of paydays (the typical day in which people receive their paycheck). Therefore, on a payday, environment program 122 may reference a calendar, and based on determining that it is a payday, may turn on the air conditioning (for the entire day or for certain time periods of the day).

Furthermore, environment profiles may be created based on historical information collected by environment program 122 from wearable devices (and other computing devices) via network 130. For example, environment program 122 may collect temperature preference information from wearable devices that enter the environment associated with environment program 122 over the course of multiple weeks, months, or years. Environment program 122 may then analyze this information in order to create a temperature profile. In the example embodiment, environment program 122 may determine a consensus desired temperature for a specific time on a specific day of the week. For example, environment program 122 may determine a consensus desired temperature for 4 to 5 pm on Tuesday. In another example, environment program 122 may collect television preference information in order to determine a consensus as to the overall preferred television programming (or seasonal preference).

In the example embodiment, environment program 122 determines whether one or more profiles related to the environment need to be updated (decision 210) based on comparing the information retrieved from wearable devices detected in the environment (such as wearable device 110) during a given time period to one or more profiles related to the environment. For example, if environment program 122 retrieves temperature preference information for the month of May which differs from the temperature profile for the month of May, environment program 122 may update the temperature profile. In the example embodiment, the retrieved temperature preference information differs from the temperature profile if the retrieved temperature information is at least a certain threshold percentage different than the corresponding information contained in the temperature profile. In the example embodiment, the certain threshold percentage is 5%, however, in other embodiments, the certain threshold percentage may be a different value. For example, if the retrieved temperature information for a certain time period (a Wednesday in May) is 80 degrees and the corresponding temperature information contained in the temperature profile for that certain period of time (Wednesdays in May) is 82 degrees, environment program 122 determines that the retrieved temperature information is within the certain threshold percentage (5%) of the corresponding information in the temperature profile, and therefore, the specific temperature profile (for Wednesdays in May) does not need to be updated.

In the example embodiment, if environment program 122 determines that the temperature do need to be updated, the temperature information may be averaged with the temperature information in the profile (while in some cases placing extra weight to the most recently collected temperature information). In another embodiment, environment program 122 may replace the profile with a profile reflecting the most recently collected temperature information for the month of May.

If environment program 122 determines that one or more profiles related to the environment need to be updated (decision 210, “YES” branch), environment program 122 updates the one or more profiles (step 212). If environment program 122 determines that one or more profiles related to the environment do not need to be updated (decision 210, “NO” branch), environment program 122 continues to detect for wearable devices and retrieve information.

While in the example embodiment, environment program 122 receives information from wearable device 110, in other embodiments, environment program 122 may receive information from a plurality of wearable devices. Furthermore, environment program 122 may update the conditions of the environment based on the information received from the plurality of wearable devices. In this embodiment, environment program 122 may determine a consensus or an average in relation to the information received. For example, environment program 122 may receive temperature related information from the plurality of weather devices (whether the temperature is too hot or too cold, etc.), and based on the received information, environment program 122 may determine an average temperature. The average temperature may then be compared to the environment conditions in order to determine whether the conditions need to be altered.

The foregoing description of various embodiments of the present invention has been presented for purposes of illustration and description. It is not intended to be exhaustive nor to limit the invention to the precise form disclosed. Many modifications and variations are possible. Such modifications and variations that may be apparent to a person skilled in the art of the invention are intended to be included within the scope of the invention as defined by the accompanying claims.

FIG. 3 depicts a block diagram of components of wearable device 110, and server 120 of an adaptation system 100 of FIG. 1, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Wearable device 110 and server 120 include respective communications fabric 302, which provides communications between computer processor(s) 304, memory 306, persistent storage 308, communications unit 312, and input/output (I/O) interface(s) 314. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 316 and cache memory 318. In general, memory 306 can include any suitable volatile or non-volatile computer-readable storage media.

The programs environment program 122 stored in server 120 are stored in persistent storage 308 for execution and/or access by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 312, in these examples, provides for communications with other data processing systems or devices. In these examples, communications unit 312 includes one or more network interface cards. Communications unit 312 may provide communications through the use of either or both physical and wireless communications links. The programs environment program 122 stored in server 120 may be downloaded to persistent storage 308 through communications unit 312.

I/O interface(s) 314 allows for input and output of data with other devices that may be connected to wearable device 110 and server 120. For example, I/O interface 314 may provide a connection to external devices 320 such as a keyboard, keypad, a touch screen, and/or some other suitable input device. External devices 320 can also include portable computer-readable storage media such as, for example, thumb drives, portable optical or magnetic disks, and memory cards. Software and data used to practice embodiments of the present invention, e.g., the program environment program 122 in server 120, can be stored on such portable computer-readable storage media and can be loaded onto persistent storage 308 via I/O interface(s) 314. I/O interface(s) 314 can also connect to a display 322.

Display 322 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge devices. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or device. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for adapting an environment, comprising the steps of:
detecting one or more portable computing devices in an environment;
receiving information detailing one or more user preferences from the one or more portable computing devices;
determining whether to update one or more conditions of the environment based on comparing the received information to the one or more conditions of the environment; and
based on determining to update the one or more conditions of the environment, updating the one or more conditions of the environment.

2. The computer implemented method of claim 1, further comprising:
determining whether to update one or more profiles associated with the environment based on comparing the received information to the one or more profiles of the environment; and
based on determining to update the one or more profiles associated with the environment, updating the one or more profiles associated with the environment.

3. The computer implemented method of claim 2, wherein the one or more profiles associated with the environment are based on historical information received from portable computing devices previously detected in the environment.

4. The computer implemented method of claim 2, wherein the one or more profiles associated with the environment are based on factors including: a time of day, a time of year, a season, and a day of the week.

5. The computer implemented method of claim 1, wherein comparing the received information to the one or more conditions of the environment further comprises determining whether the received information is within a certain threshold percentage of the one or more conditions of the environment.

6. The computer implemented method of claim 1, wherein comparing the received information to the one or more conditions of the environment further comprises:
determining an average of at least one category of information included in the received information; and
determining whether the average of the at least one category of information is within a certain threshold percentage of the one or more conditions of the environment.

7. The computer implemented method of claim 1, wherein the user preferences may include information detailing at least one of: heart rate information of the user, a body temperature of the user, an emotional state of the user, information related to the motion of the user, a preferred temperature setting, social media information associated with the user, preferred music associated with the user, and one or more favorite television channels.
